(19) United States
(12) Patent Application Publication
(10) Pub. No.: US 2024/0241822 A1
(43) Pub. Date: Jul. 18, 2024

(54) CODE IMPLEMENTATION MISSING DETECTION APPARATUS, CODE IMPLEMENTATION MISSING DETECTION METHOD AND PROGRAM

(71) Applicant: NIPPON TELEGRAPH AND TELEPHONE CORPORATION, Tokyo (JP)

(72) Inventors: Shmuel UR, Galil (IL); Ziv GLAZBERG, Ramat Gan (IL); Ran LEHR, Tel-Aviv (IL); Erez KEINAN, Rishon Le-zion (IL)

(21) Appl. No.: 18/561,935

(22) PCT Filed: May 27, 2021
(86) PCT No.: PCT/JP2021/020309

§ 371 Date: Nov. 17, 2023

(51) Int. Cl. G06F 11/36

(52) U.S. Cl. CPC G06F 11/3692; G06F 11/3676

(57) ABSTRACT

An unimplemented code detection device includes: an acquisition unit that acquires an execution result and a coverage of a test executed by a test target system on the basis of an input, and an execution result and a coverage of a test executed by a reference model on the basis of the input; and a determination unit that compares the coverage of the test by the test target system with the coverage of the test by the reference model, to determine whether there is an unimplemented code in the test target system, when the execution result of the test by the test target system is incorrect.

### TECHNICAL FIELD

The present invention relates to a technology for detecting an unimplemented code in software development.

### BACKGROUND ART

As a method for testing software, there is a method of determining whether the software is normal by giving an input to the software, executing the software, and comparing the output (execution result) with an expected result. The expected result is a result to be obtained when the software is correctly executed.

In a case where an execution result is different from the expected result, it is necessary to debug the software. Debugging is a time-consuming process that requires a great amount of expertise.

### CITATION LIST

### Non Patent Literature

Non Patent Literature 1: “Basic Concept of Test Automation, and Research and Development at NTT”, the 25th SPI Twilight Forum, 2019/3/26 http://www.jaspic.org/wordpress/wp-content/uploads/JASPIC_SPI-TwilightForum_20190326.pdf

### SUMMARY OF INVENTION

### Problem to be Solved

Since it takes a great amount of operation to find a bug in debugging, it is desirable to be able to automatically detect what is wrong with the software.

Particularly, an unimplemented code is a bug that frequently occurs. Therefore, if an unimplemented code can be automatically detected, the amount of operation in debugging can be reduced.

The present invention has been made in view of the above aspect, and aims to provide a technology for enabling automated detection of an unimplemented code in software.

### Solution to Problem

The technology disclosed herein is to provide an unimplemented code detection device that includes: an acquisition unit that acquires an execution result and a coverage of a test executed by a test target system on the basis of an input, and an execution result and a coverage of a test executed by a reference model on the basis of the input; and a determination unit that, when the execution result of the test by the test target system is incorrect, compares the coverage of the test by the test target system with the coverage of the test by the reference model, to determine whether there is an unimplemented code in the test target system.

### Advantageous Effects of Invention

According to the technology disclosed herein, it is possible to automatically detect an unimplemented code in software.

### BRIEF DESCRIPTION OF DRAWINGS

FIG. 1 is a configuration diagram of a system according to an embodiment of the present invention.

FIG. 2 is a configuration diagram of an unimplemented code detection device.

FIG. 3 is a flowchart of processing.

FIG. 4 is a diagram illustrating an example of a table.

FIG. 5 is a table for explaining an example case where two tests are used.

FIG. 6 is a diagram illustrating an example hardware configuration of the unimplemented code detection device.

### DESCRIPTION OF EMBODIMENTS

The following is a description of an embodiment (the present embodiment) of the present invention, with reference to the drawings. The embodiment described below is merely an example, and embodiments to which the present invention is applied are not limited to the embodiment described below.

### Overview of an Embodiment

A test method (setup) according to the present embodiment is a common method that is used in unit tests and the like. Specifically, a code of the software to be tested is created first.

Note that, in software development, when a plurality of programming languages is developed in combination (in a mix-and-match manner), a code may be created by a method for converting one language into another language. For example, a development method for creating a code in a high-level language and then converting the code into a code (a production code) in a low-level language may be used.

Next, a test input is created. The input may be created manually, or may be created with an automated test generator. A test is then conducted on the software to be tested, using the test input. Note that “software” may be referred to as a “system”.

As described later, in the present embodiment, both a system A (a test target system, for example) and a system B (a reference model) are executed with various test inputs, and an unimplemented code is detected on the basis of outputs of both systems and the coverage of the test with the used input. In the description below, the present embodiment is explained in greater detail.

### (Example System Configuration)

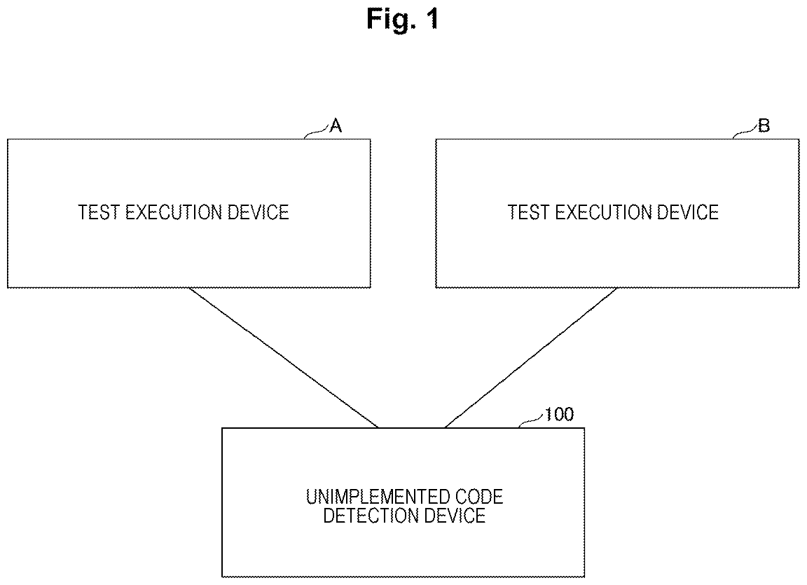

In the description below, an example configuration of a system according to the present embodiment is explained with reference to FIG. 1. As illustrated in FIG. 1, this system includes a test execution device A, a test execution device B, and an unimplemented code detection device 100. The test execution device A and the test execution device B are each connected to the unimplemented code detection device 100 via a network.

Each of the test execution device A, the test execution device B, and the unimplemented code detection device 100 is a computer capable of executing software (a program). Each of the test execution device A, the test execution device B, and the unimplemented code detection device 100 may be a physical machine, or may be a virtual machine in a cloud.

Note that, in the present embodiment, three devices are used as the test execution device A, the test execution device B, and the unimplemented code detection device 100, but this is merely an example. For example, one device including the functions of the test execution device A, the test execution device B, and the unimplemented code detection device 100 may be used.

Both the test execution device A and the test execution device B execute software using an input for a test, and output execution results. “Executing software using an input for a test” may be referred to as a “test”.

In either of the test execution device A and the test execution device B, the software may be operated manually through an input, or may be automatically operated with a script or the like.

The execution result (output) of each test conducted by the test execution device A and the test execution device B is input to the unimplemented code detection device 100.

The execution results to be output may include any information such as a numerical value, an image of a screen, a table stored in a database, or an execution log, for example.

The unimplemented code detection device 100 compares the output from the test execution device A with the output from the test execution device B, determines whether the execution result of the test target system is correct, acquires the coverage of the executed test, and determines the presence/absence of a code not implemented in the test target system, on the basis of the results.

### (Example Configuration and Example Operation of the Unimplemented Code Detection Device)

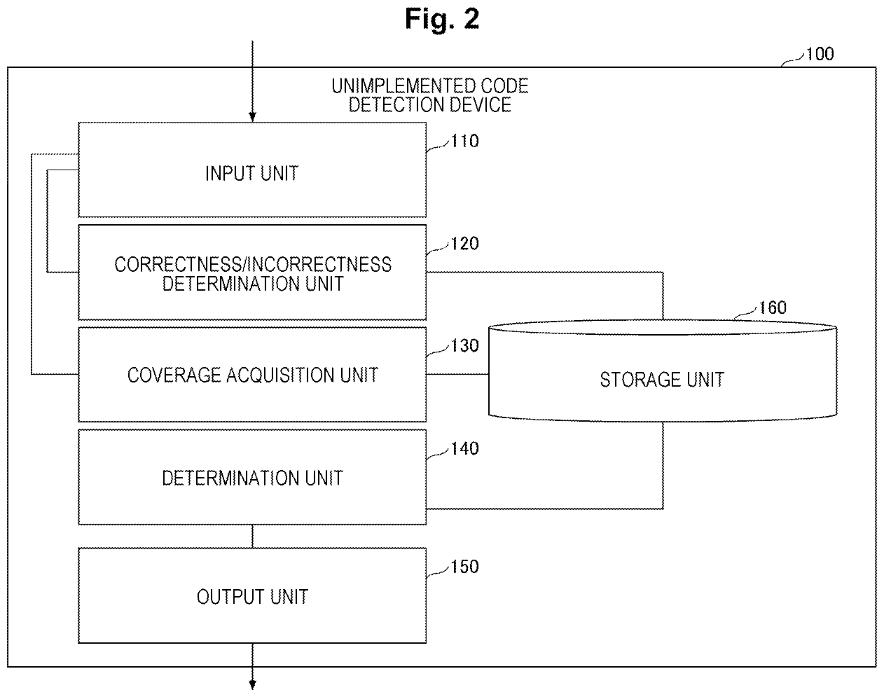

FIG. 2 illustrates an example configuration of the unimplemented code detection device 100. As illustrated in FIG. 2, the unimplemented code detection device 100 includes an input unit 110, a correctness/incorrectness determination unit 120, a coverage acquisition unit 130, a determination unit 140, an output unit 150, and a storage unit 160.

Note that the function that is executed by the input unit 110, the correctness/incorrectness determination unit 120, the coverage acquisition unit 130, and the like to acquire an execution result and a coverage may be called the “acquisition unit”. Also, the function that is executed by the correctness/incorrectness determination unit 120 and the determination unit 140 to perform determination may be called the “determination unit”.

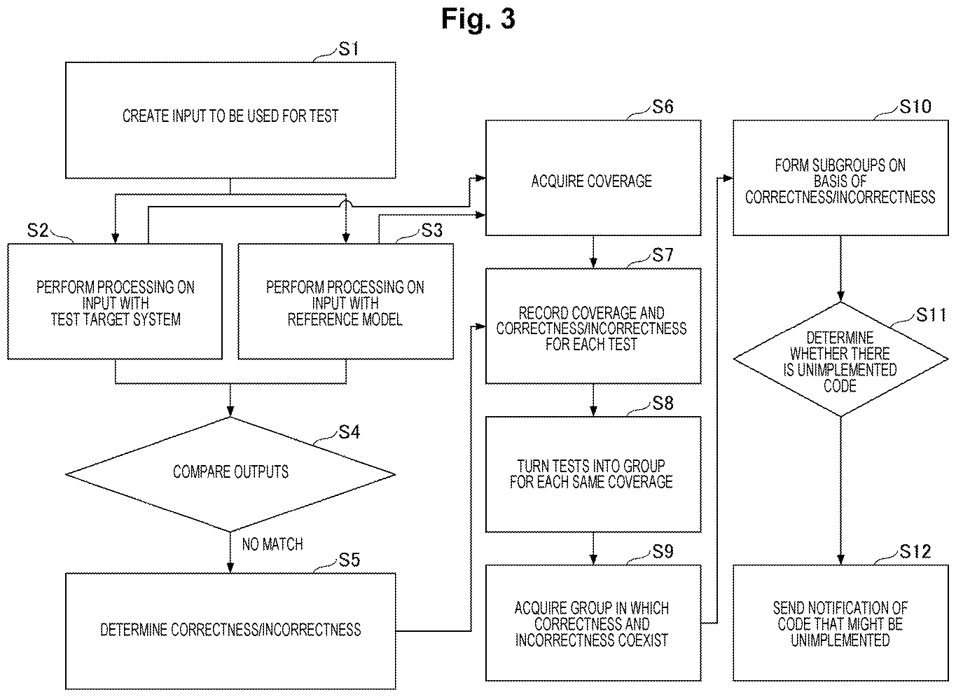

An example operation of the system including the unimplemented code detection device 100 is now described with reference to a flowchart shown in FIG. 3.

The description below is based on the assumption that the test execution device A executes a test on the test target system (software), and the test execution device B executes a test on the reference model, for example.

The reference model is a system that is known to perform correct operations (correct outputs), and it is possible to determine whether an output of the test target system is correct, by comparing the output of the test target system with an output of the reference model.

As an example, the reference model is software that performs a stable operation before version upgrade, and the test target system is an upgraded version of software having the same functions as those of the reference model. A test in such a case is also called a regression test.

Further, there are cases where the test execution device B that executes the reference model is a terminal of a certain model that performs stable operations, and the test target system is the software obtained by modifying the reference model for the test execution device A that is a terminal of a different model from the terminal as the test execution device B. Also, the codes before and after the conversion at the time of development in a mix-and-match manner may be used as the reference model and the test target system, respectively.

Note that the above is merely an example, and the reference model may not necessarily output a correct result. That is, both the test execution device A and the test execution device B may execute the test target system.

In the example described below, the test target system and the reference model have already been created, and been installed in the test execution devices A and B so that tests can be conducted.

### <S1 (Step 1)>

In S1, an input for a test is created. The input for a test may be a numerical value to be input to the system, procedures for an input to the system (procedures such as pressing a button A, inputting a value B, and clicking an OK button), or some other procedures. The input for a test may be created manually, or may be created automatically.

The input for a test created in S1 is given to each of the test target system of the test execution device A and the reference model of the test execution device B.

Also, the input for a test created in S1 is stored, together with identification information such as “test 1, test 2, . . . ”, for example, into the storage unit 160 of the unimplemented code detection device 100. Note that S2 to S7 described below are carried out for each of various inputs. Also, information necessary for performing the processing described below is stored in the storage unit 160.

### <S2>

In S2, the test execution device A executes the test target system on the basis of the given input. The execution result (output) is input to the input unit 110 of the unimplemented code detection device 100.

### <S3>

In S3, the test execution device B executes the reference model on the basis of the given input. The execution result (output) is input to the input unit 110 of the unimplemented code detection device 100.

### <S4>

In S4, the correctness/incorrectness determination unit 120 (which may be called the “comparison unit”) of the unimplemented code detection device 100 compares the output of the test target system with the output of the reference model. Although it is assumed that the comparison is automatically performed herein, the comparison and the correctness/incorrectness determination in S5 described below may be performed manually.

### <S5>

In S5, the correctness/incorrectness determination unit 120 determines correctness/incorrectness of the output of the test target system and the output of the reference model, on the basis of the comparison result. Since it is assumed here that the output of the reference model is correct, the output of the test target system is determined to be incorrect if the output of the test target system and the output of the reference model do not match, and the output of the test target system is determined to be correct if the output of the test target system and the output of the reference model match.

Also, in a case where the output of the reference model is not necessarily correct (which is a case where the reference model is another test target system), both the output of the test target system and the output of the reference model may be determined to be correct if the two outputs match, and the output that matches another prepared expected result may be determined to be correct if the two outputs do not match, for example.

### <S6>

In S6, the coverage acquisition unit 130 acquires the coverage for the test executed on the test target system. The coverage is information indicating which row of the system (software) has been executed (covered) in the execution of the test, for example. For example, if the first to fourth rows, and the 89th to 108th rows are covered among 200 rows, “the first to fourth rows, and the 89th to 108th rows” is the coverage information.

The coverage information may be acquired by actual measurement using a tool or the like in the test execution device A, or may be prepared in advance for each test.

Likewise, the coverage acquisition unit 130 also acquires the coverage for the test executed on the reference model.

### <S7>

The result of the correctness/incorrectness determination performed by the correctness/incorrectness determination unit 120 is associated with the corresponding test, and is recorded into the storage unit 160. Also, the coverage information acquired by the coverage acquisition unit 130 is associated with the corresponding test, and is recorded into the storage unit 160.

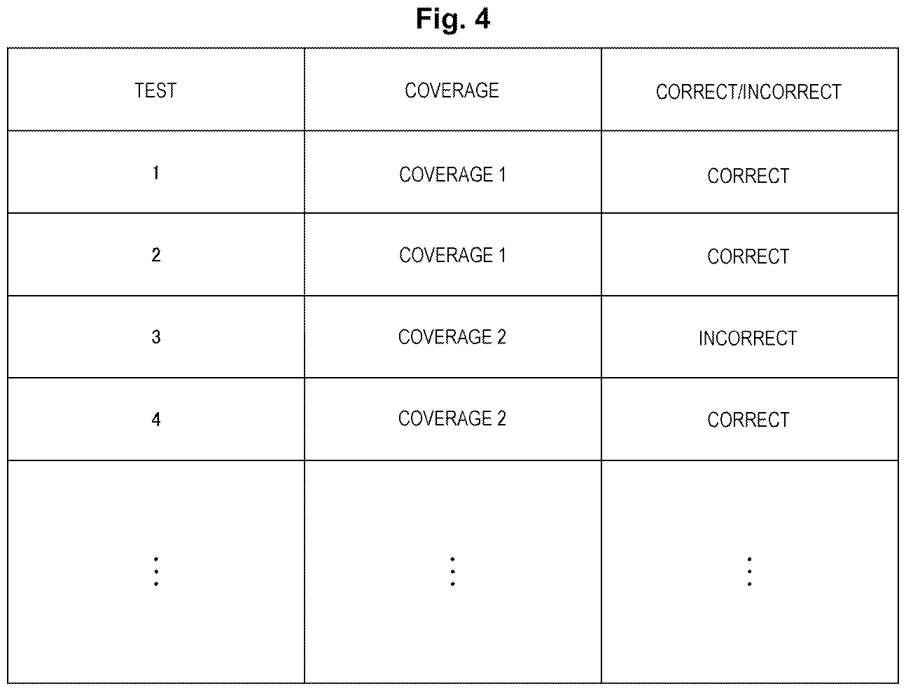

FIG. 4 shows an example of a table stored in the storage unit 160 for the test target system. As illustrated in FIG. 4, the coverage and the correctness/incorrectness of the output is recorded for each test. A similar table is also recorded for the reference model. However, it is assumed here that all execution results in the reference model are correct.

### <S8>

In S8, the determination unit 140 groups the tests in the test target system for each test having the same coverage, on the basis of the information stored in the storage unit 160. For example, in the example in FIG. 4, in a case where the coverages of test 1 and test 2 are the same (coverage 1), and the coverages of test 3 and test 4 are the same (coverage 2, which is different from coverage 1), test 1 and test 2 are in a group, and test 3 and test 4 are in another group.

### <S9>

In S9, the determination unit 140 extracts a group including tests with correct execution results and tests with incorrect execution results from the plurality of groups obtained in S8.

### <S10>

In S10, the determination unit 140 divides the test group included in the group extracted in S9, into a test group with correct execution results and a test group with incorrect execution results. For example, where the test group (a test group having the same coverage) included in the group is tests 6, 7, 8, and 9, and the execution results of tests 6 and 7 are correct while the execution results of tests 8 and 9 are incorrect, the test group is divided into “tests 6 and 7” and “tests 8 and 9”.

### <S11>

In S11, for each group extracted in S9 (for each same coverage group in the test target system), the determination unit 140 checks the coverage in the reference model for each test in the test group that has been obtained by the dividing in S10 and has incorrect execution results.

In the test target system, the determination unit 140 determines whether the coverage of a test with an incorrect execution result in a coverage group differs from the coverage of the test (with a correct execution result) in the reference model, and, if the coverages differ from each other, determines that there is an unimplemented code in the test target system.

For example, in a case where the execution results of “tests 8 and 9” with “coverage 2” are incorrect in the test target system, if the coverage of the reference model for test 8 is “coverage 2”, and the coverage of the reference model for test 9 is “coverage 3”, the determination unit 140 determines that there is an unimplemented code related to test 9 in the test target system.

That is, when the coverage in the reference model that outputs a correct result for test 9 is different from the coverage in the test target system that outputs an incorrect result for test 9, it can be assumed that there is an unimplemented code in the test target system, and the output is incorrect. Thus, the above determination can be made.

Note that “an unimplemented code” may indicate a case where a code is missing, or may indicate a case where an unnecessary code is additionally written, leading to execution of an erroneous operation. Any of these cases can be detected by the coverage comparison described above.

### <S12>

In S12, the output unit 150 notifies the team that has developed the test target system, that there is an unimplemented code regarding a certain test, for example.

In a case where an unimplemented code regarding test 9 is detected, for example, the output unit 150 (or the determination unit 140) may determine that there is an unimplemented code among the codes in the coverage of test 9 in the reference model, and sends the above notification together with the codes in the coverage of test 9 in the reference model.

S1 to S12 have been described above. Note that the grouping and the proceeding with the processing described above is an example. In a case where the execution result differs between the reference model and the test target system for a test, any processing method by which the coverages for the test can be compared may be used.

(Example in which Test Target Systems A and B are Used)

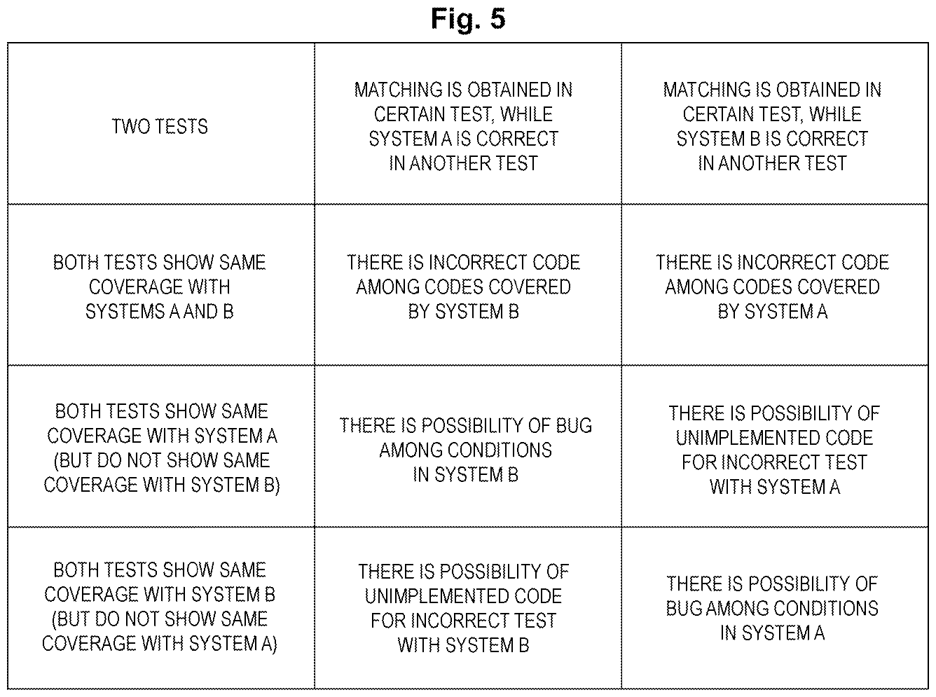

As mentioned above, the reference model may be another test target system. FIG. 5 illustrates an example of determination (an example output of a determination result) performed by the unimplemented code detection device 100 in a case where two tests are executed on each of the test target system A and the test target system B.

The test target system A and the test target system B are software having the same functions, and are software created for different devices, for example. Whether an output for each test is correct can be determined from an expected result prepared in advance.

In the description below and FIG. 5, the test target system A and the test target system B are referred to as the “system A” and the “system B”, respectively. Further, “matching” means that the execution results of the test target system A and the test target system B match, and the execution results are both correct herein. Each row in FIG. 5 is now described.

In a case where both tests show the same coverage in each of the systems A and B, matching is obtained in one test, and the system A is correct in the other test, it is determined that there is an incorrect code among the codes covered by the system B.

In a case where both tests show the same coverage in each of the systems A and B, matching is obtained in one test, and the system B is correct in the other test, it is determined that there is an incorrect code among the codes covered by the system A.

In a case where both tests show the same coverages with the system A, the same coverages are not obtained with the system B, matching is obtained in one test, and the system A is correct in the other test, it is determined that there may be a bug among the conditions in the system B.

In a case where both tests show the same coverages with the system A, the same coverages are not obtained with the system B, matching is obtained in one test, and the system B is correct in the other test, it is determined that there may be an unimplemented code for the incorrect test with the system A.

In a case where both tests show the same coverages with the system B, the same coverages are not obtained with the system A, matching is obtained in one test, and the system A is correct in the other test, it is determined that there may be an unimplemented code for the incorrect test with the system B.

In a case where both tests show the same coverages with the system B, the same coverages are not obtained with the system A, matching is obtained in one test, and the system B is correct in the other test, it is determined that there may be a bug among the conditions in the system A.

### (Example Hardware Configuration)

The unimplemented code detection device 100 can be formed with a computer caused to execute a program, for example. This computer may be a physical computer, or may be a virtual machine in a cloud.

Specifically, the unimplemented code detection device 100 can be formed with a computer executing a program corresponding to the processing to be performed in the unimplemented code detection device 100, using hardware resources such as a CPU and a memory built into the computer. The above program is recorded in a computer-readable recording medium (such as a portable memory) so that the program can be stored and distributed. Furthermore, the above program can also be provided through a network such as the Internet or an electronic mail.

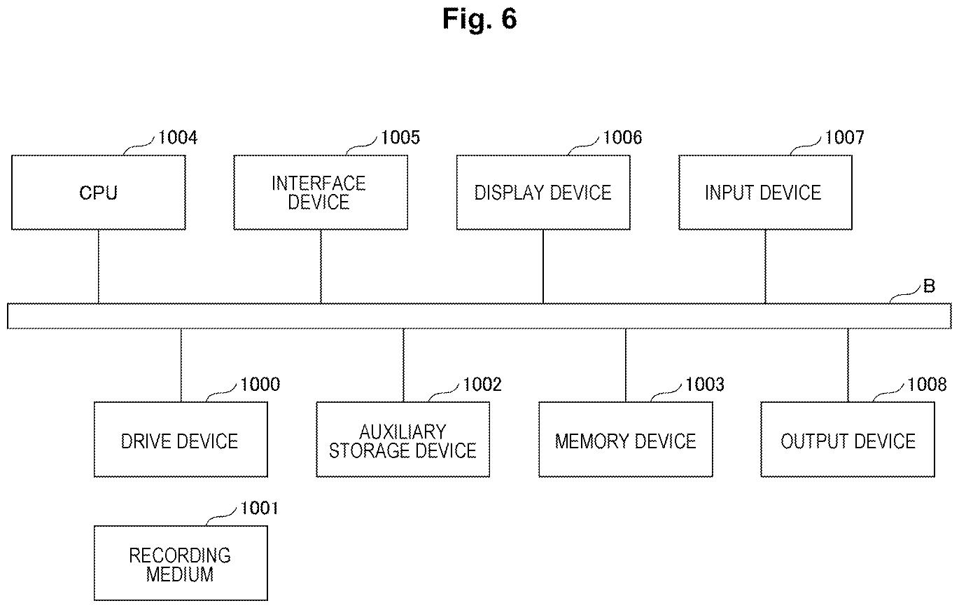

FIG. 6 is a diagram illustrating an example hardware configuration of the computer. The computer in FIG. 6 includes a drive device 1000, an auxiliary storage device 1002, a memory device 1003, a CPU 1004, an interface device 1005, a display device 1006, an input device 1007, and an output device 1008, which are connected to one another by a bus BS.

The program for implementing the processing in the computer is provided by, for example, a recording medium 1001 such as a CD-ROM or a memory card. When the recording medium 1001 that stores the program is set in the drive device 1000, the program is installed from the recording medium 1001 into the auxiliary storage device 1002 via the drive device 1000. However, the program is not necessarily installed from the recording medium 1001, and may be downloaded from another computer via a network. The auxiliary storage device 1002 stores the installed program and also stores necessary files, data, and the like.

In a case where an instruction to start the program is issued, the memory device 1003 reads the program from the auxiliary storage device 1002, and stores the program therein. The CPU 1004 implements functions related to the unimplemented code detection device 100, in accordance with the program stored in the memory device 1003. The interface device 1005 is used as an interface for connection to a network or the like. The display device 1006 displays a graphical user interface (GUI) or the like according to the program. The input device 1007 includes a keyboard and a mouse, buttons, a touch panel, or the like, and is used to input various operation instructions. The output device 1008 outputs a calculation result.

### Effects of the Embodiment

As described above, by the technology according to the present embodiment, it is possible to automatically detect an unimplemented code in software.

Further, not only the presence/absence of an unimplemented code but also a missing code can be detected, and a notification thereof can be sent as a comment or the like.

### SUMMARY OF THE EMBODIMENT

The present specification discloses at least the unimplemented code detection device, the unimplemented code detection method, and the program described in the following items.

### (Item 1)

An unimplemented code detection device including: an acquisition unit that acquires an execution result and a coverage of a test executed by a test target system on the basis of an input, and an execution result and a coverage of a test executed by a reference model on the basis of the input; and a determination unit that, when the execution result of the test by the test target system is incorrect, compares the coverage of the test by the test target system with the coverage of the test by the reference model, to determine whether there is an unimplemented code in the test target system.

### (Item 2)

The unimplemented code detection device of item 1, wherein the determination unit compares the execution result of the test by the test target system with the execution result of the test by the reference model, and, when the execution results do not match, determines that the execution result of the test by the test target system is incorrect.

### (Item 3)

The unimplemented code detection device of item 1 or 2, wherein, when the execution result of the test by the test target system is incorrect, and the coverage of the test by the test target system is different from the coverage of the test by the reference model, the determination unit determines that there is an unimplemented code in the test target system.

### (Item 4)

The unimplemented code detection device of any one of items 1 to 3, wherein, when determining that there is an unimplemented code in the test target system, the determination unit determines that there is a code unimplemented in the test target system among codes in the coverage of the test by the reference model.

### (Item 5)

An unimplemented code detection method implemented by a computer, the unimplemented code detection method including: a step of acquiring an execution result and a coverage of a test executed by a test target system on the basis of an input, and an execution result and a coverage of a test executed by a reference model on the basis of the input; and a step of, when the execution result of the test executed by the test target system is incorrect, comparing the coverage of the test by the test target system with the coverage of the test by the reference model, to determine whether there is an unimplemented code in the test target system.

### (Item 6)

A program for causing a computer to function as each unit in the unimplemented code detection device of any one of items 1 to 4.

Although the present embodiment has been described above, the present invention is not limited to such a specific embodiment, and various modifications and changes can be made within the scope of the present invention disclosed in the claims.

### REFERENCE SIGNS LIST

A, B test execution device
100 unimplemented code detection device
110 input unit
120 correctness/incorrectness determination unit
130 coverage acquisition unit
140 determination unit
150 Output unit
160 storage unit
1000 drive device
1001 recording medium
1002 auxiliary storage device
1003 memory device
1004 CPU
1005 interface device
1006 display device
1007 input device

1. An unimplemented code detection device comprising:
circuitry configured to
acquire (i) a first result and a first coverage of a first test that a test target system runs based on an input, and (ii) a second result and a second coverage of a second test that a reference model runs based on the input, and
compare, upon occurrence of a condition in which the first result is incorrect, the first coverage of the first test with the second coverage of the second test, to determine whether there is an unimplemented code in the test target system.

2. The unimplemented code detection device according to claim 1, wherein the circuitry is configured to
compare the first result of the first test with the second result of the second test, and
determine, upon occurrence of a condition in which the first result and the second result do not match, that the first result of the first test is incorrect.

3. The unimplemented code detection device according to claim 1, wherein upon occurrence of a condition in which (i) the first result of the first test is incorrect, and (ii) the first coverage of the first test is different from the second coverage of the second test, the circuitry is configured to determine that there is the unimplemented code in the test target system.

4. The unimplemented code detection device according to claim 1, wherein the circuitry is configured to determine, upon determining that there is the unimplemented code in the test target system, that there is a code that is not embodied in the test target system, in codes that are included in the second coverage of the second test.

5. An unimplemented code detection method executed by a computer, the unimplemented code detection method comprising:
acquiring (i) a first result and a first coverage of a first test that a test target system runs based on an input, and (ii) a second result and a second coverage of a second test that a reference model runs based on the input; and
comparing, upon occurrence of a condition in which the first result of the first test is incorrect, the first coverage of the first test with the second coverage of the second test, to determine whether there is an unimplemented code in the test target system.

6. A non-transitory computer readable medium storing a program for causing a computer to execute the unimplemented code detection method of claim 5.
